(19) United States
(12) Patent Application Publication
(10) Pub. No.: US 2020/0324429 A1
(43) Pub. Date: Oct. 15, 2020

(54) RELEASE AGENT SUPPLY DEVICE FOR COLD KNIFE WEAKENING AND A COLD KNIFE SYSTEM COMPRISING SUCH A DEVICE

(71) Applicant: FAURECIA (CHINA) HOLDING CO., LTD., Shanghai (CN)

(72) Inventor: Hao SHANG, Shanghai (CN)

(21) Appl. No.: 16/305,611

(22) PCT Filed: May 31, 2016
(86) PCT No.: PCT/CN2016/084043

§ 371 Date: Nov. 29, 2018

(51) Int. Cl. B26D 3/08; B60R 21/2165

(52) U.S. Cl. CPC B26D 3/085; B26D 7/08; B60R 21/2165

(57) ABSTRACT

A release agent supply device for cold knife weakening comprising: —a wheel which adapted to roll in a weakening line formed by cold knife weakening; —a nozzle, the opening of the nozzle is close to the rim of the wheel with a small distance (d1) and orients to the wheel; and —a release agent feeder which is in fluid communication with the nozzle for providing the release agent to the nozzle; wherein the nozzle is adapted to supply the release agent to the wheel, and the wheel is adapted to apply the release agent to the weakening line when rolling therein The release agent supply device comprises simple structure, and is easy to be added on the ordinary cold knife.

### TECHNICAL FIELD

The present invention relates to cold knife weakening on a vehicle interior trim having weakening area such as an airbag cover. More particularly, the present invention relates to a release agent supply device for the cold knife weakening, and also relates to a cold knife system comprising such a device.

### BACKGROUND TECHNOLOGY

A vehicle interior trim, for example an instrument panel, is usually provided integrally with a weakening area, for example an airbag cover for developing an airbag when the latter is exploding under certain emergency conditions.

In the art, the airbag cover is a part of the interior trim located corresponding to the position of an airbag thereunder. In order to make the airbag break through the interior trim to provide protection as designed, the airbag cover is an area on the interior trim defined by break-scheduled lines, which may be also referred to as a split line, as a thin-walled portion for reliably opening the airbag by the deployment force thereof.

For the aesthetic appearance, these break-scheduled lines are usually weakening lines formed from the back side of a skin of the interior trim, so that these lines are invisible from the outside. These weakening lines are obtained by means of cold knife weakening, hot blade weakening, milling weakening or laser weakening, among which the cold knife weakening are widely employed.

When the weakening lines are cut by cold knife weakening, it further requires apply release agent in the weakening lines so as to prevent regluing in the following manufacturing process, as cold knife does not remove material and foam in the weakening line does not expand.

There are some solutions in the art to apply release agent in the weakening lines. EP1960165 has disclosed a device for cutting a weakening line in a film, wherein it provides a cold blade combed with a channel for providing liquid to the tip of the blade. Indeed, such a combined blade can simultaneously cut a weakening line and apply release agent. However, the device disclosed in EP1960165 is much more complicated, especially, than ordinary cold knife. In particularly, the blade or the cold knife shall be preciously manufactured so as to form a channel therein, which raises the cost and is hard to be adapted on traditional cold knife system.

Also, in the art, there are some separate release agent supply devices developed. These separate devices are consisted of a dispenser tank, a pin adapted to moving forward and backward in a preset frequency, a pneumatic pump adapted to control the liquid drop, and a sensor adapted to detect the application accuracy of the release agent. Although these devices are capable of being attached to the ordinary cold knife, they have complicated components and structures per se, which also raises manufacturing cost and require frequent maintenance.

### DESCRIPTION OF THE INVENTION

The purpose of the present invention is to overcome these drawbacks as mentioned above.

To this end, the present invention provides a release agent supply device for cold knife weakening, comprising:
a wheel which is adapted to roll in a weakening line formed by cold knife weakening;
a nozzle, the opening of the nozzle is close to the rim of the wheel with a small distance and orients to the wheel; and
a release agent feeder which is in fluid communication with the nozzle for providing the release agent to the nozzle;

wherein the nozzle is adapted to supply the release agent to the wheel, and the wheel is adapted to apply the release agent to the weakening line, when rolling in the same.

Thanks to these arrangements, it is possible to use a simple device to apply release agent to the weakening line after the cold knife weakening without complicated and expensive structures as the ones disclosed in the art. Meanwhile, since the structure of the device according to the present invention is concise, it does not need frequent maintenance, which may greatly lower the cost and improve the manufacturing efficiency.

In various embodiments of the device according to the invention, one may possibly also have recourse to one and/or the other of the following arrangements:
the wheel has a thickness comprised between 1.5 mm to 3 mm, so that the wheel is adapted to cover or partly enter into the weakening line so as to smoothly and comprehensively apply the release agent;
the wheel has a rolling speed comprised between 20 mm/s to 40 mm/s, preferably 35 mm/s, so that the release agent can be stably applied into the weakening line;
it further comprises a holder adapted to at least hold the wheel and exert a pressure to the weakening line, so that the wheel can be positioned in a relative fixed way and the pressure exerted thereon may press the weakening line to open so as to receive the release agent in a more effective fashion; in addition, the wheel can be arranged and held in other known manner, as long as it can be positioned substantively vertically on the surface of the interior trim and come into contact with weakening line and roll therein;
the release agent feeder comprises a controllable pumper for pumping the release agent to the nozzle, and the controllable pumper is adapted to control the releasing speed of the release agent at the opening of the nozzle, so that the release agent can be applied on the weakening line in a controllable manner;
the releasing speed is preferably comprised between 0.05 g/s and 0.15 g/s, so that the release agent is adapted to be continuously and smoothly applied;
the weakening line has a residual thickness comprised between 0.5 mm and 0.7 mm, which is in favor of the profile of weakening line forming a standard airbag cover formed on the vehicle trim part;
the small distance is comprised between 1 mm and 5 mm, so that the nozzle will not interfere with the movement of the wheel while adequately providing release agent to the rim of the wheel without leaking the release agent beyond the range of rim of the wheel;

According to another aspect of the present invention, it also relates to a cold knife system for forming a cold knife a weakening line on an automobile interior trim part, comprising:
a cold knife for cutting the weakening line on the surface of the automobile interior trim part;
a release agent supply device as mentioned above; and
a connector which connects the cold knife to the release agent supply device and keeps a distance therebetween, so that they do not interfere with each other.

With these arrangements, it is possible to obtain an improved cold knife system which can cut weakening lines and apply release agent in the same system without complicated structures, which lowers the cost and improves the manufacturing effect.

Alternatively, the distance between the cold knife and the release agent supply device is comprised between 10 cm and 20 cm, so that, on the one hand, the cold knife and the release agent do not interfere with each other when working, and on the other hand, they are close enough to each other so as to form a compact couple which is adapted to be installed on a single arm, for example a robot arm, so that it is more feasible to improve the current cold knife device in an easy and cost effective manner.

Preferably, the automobile interior trim part is made from PVC, TPO or PU.

According to another aspect of the present invention, it further relates to a method for forming a cold knife weakening line on an automobile interior trim part, comprising the following steps:
cutting a weakening line on the surface of the automobile interior trim part;
applying the release agent in the weakening line by means of a release agent supply device as mentioned above.

With the above arrangements, during the process of forming a weakening line, the release agent is adapted to be applied in a relatively simple and stable manner.

In general, the structure of present invention is concise, and it can reduce production cost, improve production efficiency, and easy to use while providing the above functions.

### BRIEF DESCRIPTION OF THE FIGURES

It should be understood that all features, alternatives and/or embodiments of the present invention can be associated according to various combinations in so far as they are not incompatible or exclusive with each other.

Further features and advantages of the invention will appear from the following description of embodiments of the invention, given as non-limiting examples, with reference to the accompanying drawings listed hereunder.

FIG. 1 is a lateral view of a release agent supply device according to the present invention;

FIG. 2 is a front view of a wheel of the release agent supply device according to the present invention;

FIG. 3 is a perspective view of a release agent supply device according to the present invention;

FIG. 4 is a perspective view of a cold knife system according to the present invention; and

FIG. 5 is a perspective view of a cold knife system according to the present invention from another angle.

### MORE DETAILED DESCRIPTION

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

By referring to the embodiments and figures, the present invention is described. In the figures, the same references are used to denote identical or similar items.

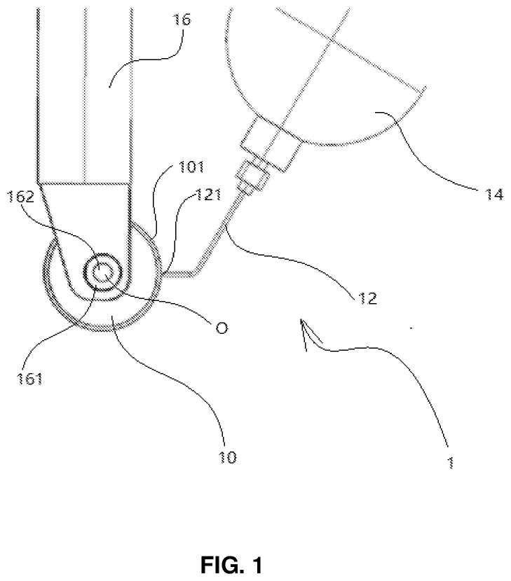

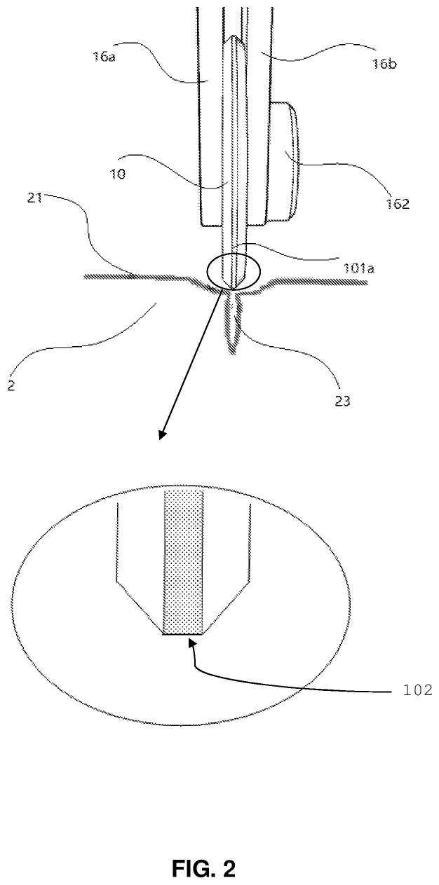

FIGS. 1 and 2 show a preferred embodiment of a release agent supply device as defined by the present invention. The release agent supply device 1 is adapted to supply release agent in liquid to weakening line 23 formed on the surface or skin 21 of a vehicle trim part 2, such as an instrument panel, made from for example PVC, TPO or PU, which defines an area of an airbag cover beneath which an airbag is located. The weakening line 23 has a residual thickness comprised between 0.5 mm and 0.7 mm and is obtained by cold knife weakening, which will be discussed hereinafter.

According to the preferred embodiment of the invention shown in FIGS. 1 and 2, the release agent supply device 1 at least comprises the following parts:
a wheel 10, which is adapted to roll in the weakening line, in a plane substantially vertical to the plane where the surface or skin 21 of a vehicle trim part 2 locates; in addition, the wheel 10 comprises a rim 101 which contacts the weakening line, and is adapted to spin with respect to its centre O;
a nozzle 12, which is in the form of a needle, wherein the opening 121 of the nozzle is close to the rim 101 of the wheel 10 with a small distance d1, comprised between 1 mm and 5 mm, and orients to the wheel, especially to the center O of the wheel; the nozzle is located in the same plane of the wheel or form a slight angle therebetween or with a small displacement;
a release agent feeder 14, which is in fluid communication with the nozzle 12 for providing the release agent to the later; wherein the nozzle 12 is adapted to supply the release agent to the wheel 10, and the wheel 10 is adapted to apply the release agent to the weakening line 23, when rolling in the same.

Alternatively, the wheel 10 is made of metal or plastic, and the rim 101 of the wheel 10 has a thickness comprised between 1.5 mm to 3 mm corresponding to the width of the weakening line whose cross section is in the form of “V” or “U”. In addition, in order to obtain a compact design, the diameter of the wheel is comprised between 1 cm and 3 cm, which is adapted to flexibly roll in the weakening line and apply the release agent in a desired manner.

Alternatively, as shown in FIG. 2, the wheel has a various thickness which is thicker in the centre area and thinner around the rim, so as to provide required thickness in the rim and overall strength to the wheel. Moreover, the face 101a of the rim 101 which contacts the weakening line is arranged to retain the release agent when receiving the same from the nozzle 12 while almost fully applying the release agent to the weakening line when rolling in the latter.

In addition, also as shown in an enlarged part of the wheel in FIG. 2, the running surface 102 of the rim may be flat or it may be rough or having a tread. An advantage of a rough surface or a surface having a tread is that the amount of release agent that adheres to the wheel can be larger than in the case of a flat surface. Another advantage of a rough surface or a surface having a tread is that the grip of the wheel on the weakening line can be better.

Advantageously, the opening 121 of the nozzle is located at or above the level of the center O of the wheel and in the upstream of the rolling direction of the wheel.

Advantageously, the release agent feeder 14 comprises a controllable pumper for pumping the release agent to the nozzle 12, so that the controllable pumper is adapted to control the releasing speed of the release agent at the opening of the nozzle, where the releasing speed is for example comprised between 0.05 g/s and 0.15 g/s.

Preferably, the release agent supply device 1 further comprises a holder 16 adapted to at least hold the wheel and exert a pressure to the weakening line.

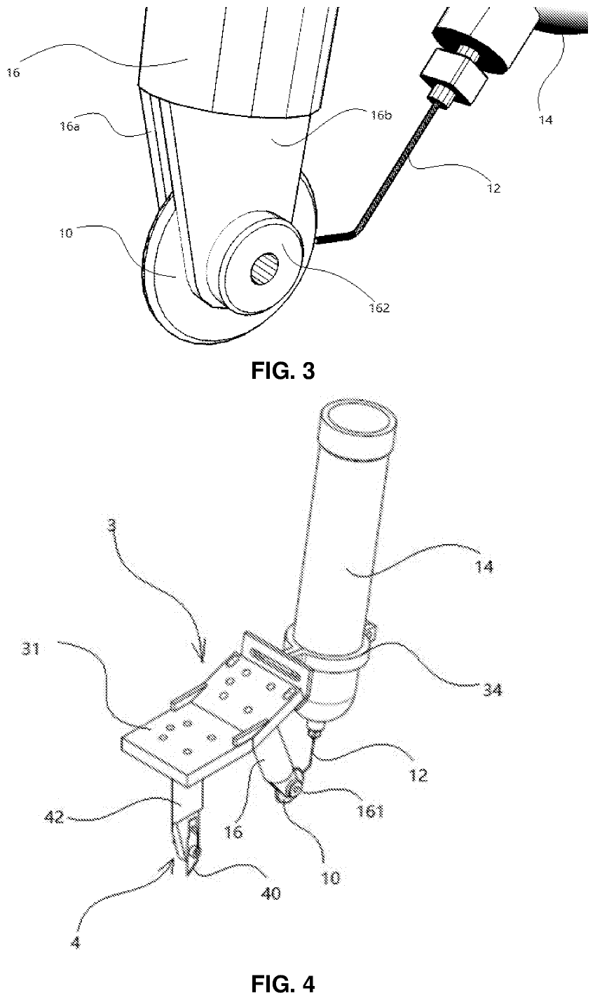

As can be observed in FIGS. 2 and 3, the holder 16 is in the form of a reversed “U” which comprises two arms 16a and 16b, a pin 161 penetrates the end of each arm and also traverses the center O of the wheel, so that the wheel is fixed between the two arms and is adapted to spin around the pin 161.

In addition, the pin 161 is fixed by a fastener 162 on the external side of the arm 16b, and the fastener 162 is adapted to clamp the arms 16a and 16b so as to make them tightly hold the wheel 10, through which the wheel 10 is stably fixed on the holder with little play between the arms while spinning around the pin 161. Moreover, the pin 161 and the fastener 162 is installed in a removable manner, so that it is possible to be released to change the wheel when necessary, especially when the wheel is broken or need to change the profile for different types of the weakening line.

Furthermore, in order to spin smoothly between the arms, the internal side of the arms and the surface of the wheel preferably have smooth face, or are proceeded by regular lubrication, such as lubricating coating.

Preferably, the holder 16 is adapted to exert a force to the wheel, and thus the wheel applies a pressure to the weakening line. By doing so, when the wheel presses the weakening line, the weakening line is tended to open its cut, so that the release agent more smoothly flows into the bottom of the weakening line.

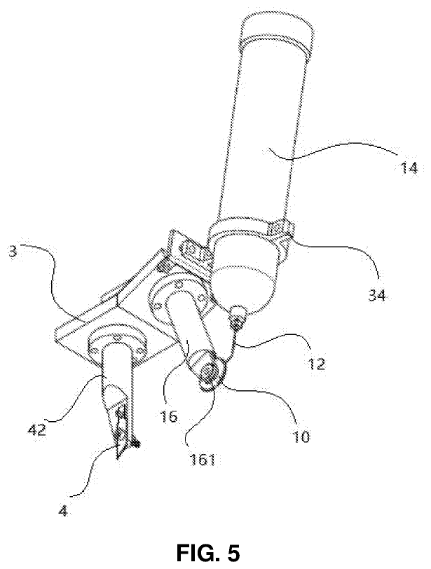

FIGS. 4 and 5 shows a preferred embodiment of a cold knife system for forming a cold knife a weakening line on an automobile interior trim part, which comprises:
a cold knife 4 for cutting the weakening line on the surface of the automobile interior trim part;
a release agent supply device 1 as mentioned above; and
a connector 3 which connects the cold knife 4 to the a release agent supply device 1 and keeps a distance d2 between them, so that they do not interfere with each other.

It can be noticed that the cold knife 4 can be any known cold knife or blade with a cutting edge 40 which is adapted to cut a weakening line on the trim part. The cold knife 4 is fixed on a knife holder 42 which is installed on the base 31 of the connector 3.

In addition, a release agent supply device 1 is fixed on its holder 16 which is installed on the base 31 of the connector 3. As shown in this embodiment, the release agent feeder 14 in the form of a tank is also attached to the bottom 31 of the connector by means of a ring clamp 34, and the nozzle 12 is fixed to the bottom of the tank.

Advantageously, the distance d2 between the cold knife 4 and the release agent supply device 1 is comprised between 10 cm and 20 cm.

Advantageously, the connector 3 is designed in a way that makes the holders 16 and 42 orienting in different directions, which means they are not parallel to each other. In particular, the base 31 of the connector 3 comprises two parts extending in two planes with angle therebetween, wherein the angle is comprised between 100 and 170 degrees.

In addition, thanks to the arrangement of the connector 3, an ordinary cold knife is adapted to be coupled with a release agent release agent supply device according to the present invention, so that the release agent release agent supply 1 can be attached to an existing cold knife system without greatly modifying the latter.

Preferably, such a cold knife system is adapted to be installed on a mechanical arm or automatic arm which may be programmed to travel according to a preset path.

In addition, a method for forming a cold knife weakening line on an automobile interior trim part may proceed, inter alia, in the following manner.

Firstly, the cold knife 4 is positioned above an interior trim part and is driven to cut a weakening line along a preset path which for example has a shape of “U”, wherein the weakening line cut by the cold knife has a residual thickness comprised between 0.5 mm and 0.7 mm, and the cross section of the cut is in the form of “V” or “U” corresponding to the cross section of the cutting edge of the cold knife.

Secondly, after the weakening line being cut, a release agent supply device 1 according to the present invention is positioned on it, and the release agent supply device 1 begins to roll along the path of the weakening line at a rolling speed comprised between 20 mm/s to 40 mm/s, preferably with a pressure so that the weakening line is tended to open to receive release agent.

When rolling in the weakening line, the release agent feeder 14 supplies release agent, preferably by means of a controllable pumper, to the nozzle 12. Then, the release agent flows from the opening 121 of the nozzle 12 to the rim 101 of the wheel 10, wherein the releasing speed is between 0.05 g/s and 0.15 g/s. Accordingly, with the rolling of the wheel, the release agent is applied to the part of the weakening line which contacts with the wheel.

In this case, the release agent is applied to the weakening line, and after the wheel rolls all along the path of the weakening line, the weakening line is fully filled with the release as required, and is ready for the next process, such as heating.

Advantageously, when the cold knife system according to the present invention is used, the weakening line is adapted to be cut and applied with the release agent by means of a single mechanical arm, which greatly reduces the manufacturing cost. In addition, since the mechanical arm is adapted to be programmed to precisely travel in a preset path, the wheel can precisely roll in the weakening line so as to apply the release agent thereto.

Those skilled in the art know many embodiments and variants and improvements. Particularly, it should be noted that, otherwise explicitly mentioned, all above described features, alternatives and/or embodiments of the present invention can be combined with each other as far as they are not incompatible or mutually exclusive of others. All such other embodiments, changes, and modifications are intended to come within the scope of the appended claims. For example, the wheel can be hold by magnetic force without physical and direct holding by a holder, the release agent supply device further comprises a detector which is adapted to detect and inspect the quality of the application of the release agent, and the nozzle comprises anti clogging means for preventing clogging of the release agent therein.

The abovementioned embodiments are used as examples and cannot be construed as limiting the scope of the utility model. On the basis of this, a man skilled in the art could expect other embodiments having same functions within the scope of protection of the present application.

1. A release agent supply device for cold knife weakening, comprising:
a wheel which is adapted to roll in a weakening line formed by cold knife weakening;
a nozzle, wherein the opening of the nozzle is adjacent the rim of the wheel and is oriented towards the wheel; and
a release agent feeder which is in fluid communication with the nozzle for providing the release agent to the nozzle;
wherein the nozzle is adapted to supply the release agent to the wheel, and the wheel is adapted to apply the release agent to the weakening line, when rolling therein.

2. The release agent supply device according to claim 1, wherein the wheel has a thickness comprised between 1.5 mm to 3 mm.

3. The release agent supply device according to claim 1, wherein the wheel has a rim comprising a rough surface or a tread.

4. The release agent supply device according to claim 1, wherein the wheel has a rolling speed comprised between 20 mm/s to 40 mm/s, preferably 35 mm/s.

5. The release agent supply device according to claim 1, further comprising a holder adapted to at least hold the wheel and exert a pressure to the weakening line.

6. The release agent supply device according to claim 1, wherein the release agent feeder comprises a controllable pumper for pumping the release agent to the nozzle.

7. The release agent supply device according to claim 6, wherein the controllable pumper is adapted to control the releasing speed of the release agent at the opening of the nozzle.

8. The release agent supply device according to claim 7, wherein the releasing speed is comprised between 0.05 g/s and 0.15 g/s.

9. The release agent supply device according to claim 1, wherein the weakening line has a residual thickness comprised between 0.5 mm and 0.7 mm.

10. The release agent supply device according to claim 1, wherein the opening in the nozzle is spaced from the rim of the wheel by a distance comprised between 1 mm and 5 mm.

11. A cold knife system for forming a cold knife a weakening line on an automobile interior trim part, comprising:
a cold knife for cutting the weakening line on the surface of the automobile interior trim part;
a release agent supply device according to claim 1; and
a connector which connects the cold knife to the release agent supply device and keeps a distance therebetween, so that they do not interfere with each other.

12. The cold knife system according to claim 11, wherein the distance is comprised between 10 cm and 20 cm.

13. The cold knife system according to claim 11, wherein the automobile interior trim part (2) is made from polyvinylchloride (PVC), thermoplastic olefin (TPO), or polyurethane (PU).

14. A method for forming a cold knife weakening line on an automobile interior trim part, comprising the following steps:
cutting a weakening line on the surface of the automobile interior trim part; and
applying the release agent in the weakening line by means of a release agent supply device according to claim 1.
